(19) United States
(12) Patent Application Publication
(10) Pub. No.: US 2006/0213421 A1
(43) Pub. Date: Sep. 28, 2006

(54) Warning device

(76) Inventor: Elke Kaltenhauser, Grafenstein (AT)

Correspondence Address: YOUNG & THOMPSON, 745 SOUTH 23RD STREET, 2ND FLOOR, ARLINGTON, VA, 22202, US

(21) Appl. No.: 11/087,630

(22) Filed: Mar. 24, 2005

(51) Int. Cl. G08B 9/00

(52) U.S. Cl. 116/22 R

(57) ABSTRACT

A warning device consisting of a holding clip (1) and a reflector (8) with two crossing arms which is attached by way of a cable or a chain (14) to the holding clip 1. On the arms of the reflector (8) there are reflecting surfaces (9). Because the reflector (8) is mounted to hang freely and movably on the holding clip (1), the light of approaching vehicles is arrhythmically relayed into the vicinity of the edge of the road so that a habituation effect does not occur in wild animals. In addition, on the clip (1) there is a reflecting surface (17) which faces the reflector (8).

The invention relates to a warning device with at least one reflector, the reflector being mounted to be able to move freely on a clip.

Conventional wild animal warning devices are mounted stationary on guide posts, on railings, on guardrails, and other road installations and uniformly reflect the light of approaching vehicles into the vicinity of the edge of the roadway, by which for a wild animal a habituation effect is established and the originally deterrent effect is lost.

An animal warning device of the initially named type is known from EP 1 380 693 A. The reflector in this known device is suspended with a swinging capacity, solely the reflector bearing reflecting foils.

The object of the invention is to devise an animal warning device of the initially mentioned type which has improved action.

This object is achieved as claimed in the invention with a warning device which has the features of claim 1.

By the configuration of the (animal) warning device as claimed in the invention the reflector is moved by air movements which are caused by natural effects (air flow such as wind) and/or by passing vehicles so that the light of the vehicle is nonuniformly relayed by the moving reflectors in the form of light flashes to the vicinity of the roadway, for example of the side of the road, and in addition is reflected by the reflecting surface which is provided on the clip. Arrhythmic movements of the reflector and thus arrhythmic reflections of the warning device as claimed in the invention which are intensified by the reflecting surface on the clip do not lead to a habituation effect in wild animals, so that the deterrent action is preserved when devices as claimed in the invention are located on the edge of roadways (roads, rail lines, etc.).

Preferred and advantageous configurations of the warning device as claimed in the invention are the subject matter of the dependent claims.

Other details of the invention arise from the following description of embodiments with reference to the drawings in which embodiments of a device as claimed in the invention in the form of a warning device for wild animals are schematically shown in an oblique view.

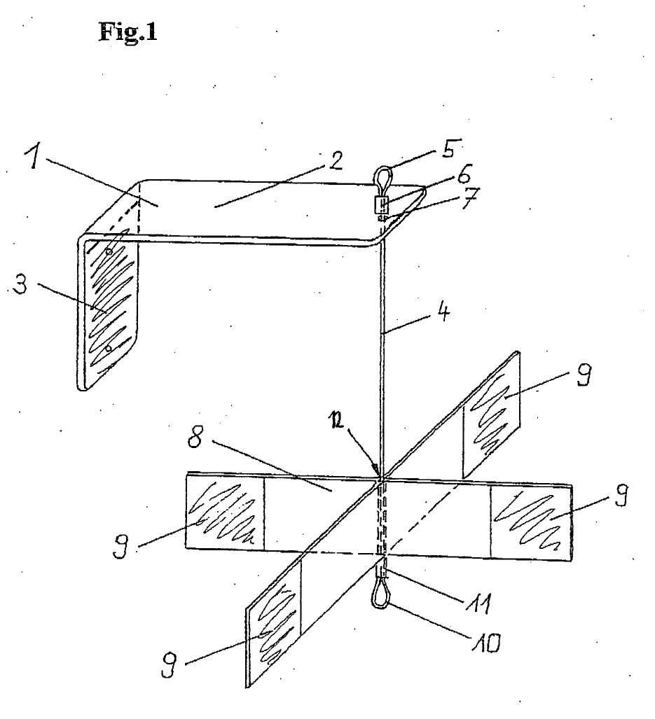

FIG. 1 shows a first embodiment of the animal warning device in which the reflector is suspended by way of a cable or cord,

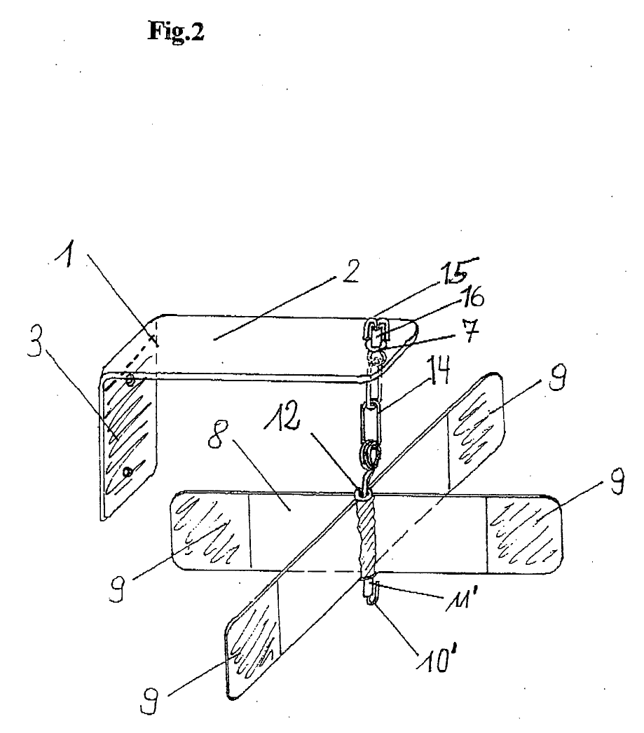

FIG. 2 shows an embodiment of the animal warning device in which the reflector is suspended by way of a chain, and

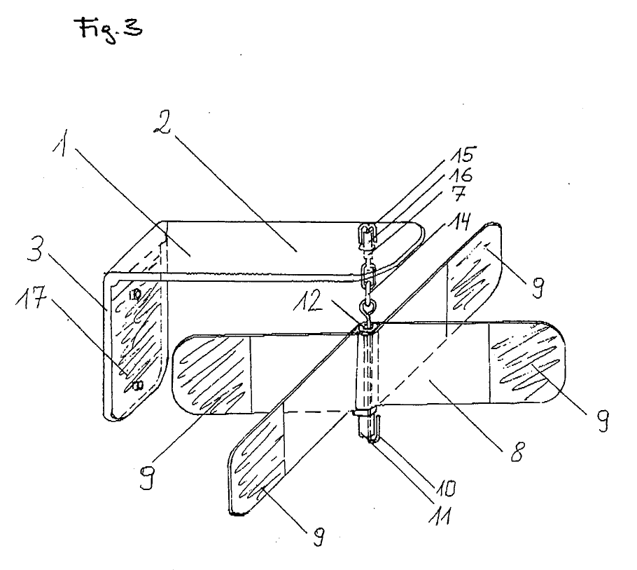

FIG. 3 shows another embodiment of the animal warning device.

The embodiment of a wild animal warning device which is shown in FIG. 1 consists of a holding clip 1 of metal or plastic which can be attached with its vertical leg 3 to a stationary component on the edge of a roadway, for example on guide posts, railings, guardrails and other road installations.

Hanging freely, a reflector 8 is attached to the leg 2 of the holding clip 1, which leg is horizontal in the position of use, such that it can execute swinging motions and can turn.

In the embodiment the reflector 8 is attached via a cord-like element 4, for example a cord or a cable, to the horizontal leg 2 of the holding clip 1.

The reflector 8 consists of two crossing arms with reflecting foils 9 attached to their outer ends (on both sides).

To attach the reflector 8 to the horizontal arm 2 of the holding clip 1 the cord-like element 4 is pulled through a hole 7 in the horizontal leg 2 of the holding clip 1 and bent into a loop 5 which is fixed using a clamp 6. The cord-like element 4 can turn in the hole 7 of the leg 2. The lower end of the cord-like element 4 is pulled through a channel 12 in the area of the crossing of the arms of the reflector 8 through the reflector 8, shaped into a loop 10 and the loop 10 is fixed using a clamp 11. Thus the reflector 8 can turn freely relative to the cord-like element 4. Moreover, the reflector 8 can execute swinging motions in addition to this rotary motion.

In the embodiment shown in FIG. 2 the reflector 8 is suspended by way of a chain 14 on the horizontal leg 2 of the holding clip 1. The uppermost link of the chain 14 is attached with a cotter pin 15 to the leg 2. For this reason the cotter pin 15 is inserted through the hole 7 in the horizontal leg 2 of the clip I and through a sleeve 16 with a flange which projects laterally down, since the uppermost chain link has been held in the annular part of the cotter pin 15 which is located underneath the horizontal leg 2. Then the ends of the cotter 15 pin are bent as shown in FIG. 2. Thus the top end of the chain 14 is fixed to the able to turn on the leg 2 of the clip 1.

The lower end link of the chain 14 is held in one end of a wire piece 10′, which end is shaped into a ring. The wire piece 10′ is inserted through the center opening (channel) 12 of the reflector 8. A sleeve 11′ with a flange which projects to the top laterally from it is inserted via the end of the wire piece 10 protruding down out of the reflector 8. The projecting end of the wire 10′ is bent. Thus the reflector 8 can turn freely relative to the chain 14 and can execute swinging motions.

In order to intensify the action of the warning device as claimed in the invention, the vertical leg 3 of the clip 1 which is attached to a stationary component is provided with a reflecting surface 17. The reflecting surface 17 which is provided on the side of the leg 3 of the clip 1 which faces the reflector 8 can be a reflecting surface 17 which has been cemented on. This results in additional reflections of the light of passing vehicles which to some extent will also be reflections of the light reflected by the reflector 8.

In the embodiment shown in FIG. 3 the chain 14 via which the reflector 8 is attached to the horizontal leg of the clip 1 is made shorter so that the reflector 8 is located nearer the horizontal leg 2 of the clip 1. Thus the reflector 8 is located with its crossing arms in a vertical position such that it is located next to the reflecting surface 17 on the vertical leg 3 of the clip 1. This has the advantage that the number of light beams which have been repeatedly reflected from the reflecting surfaces 9 on the reflector 8 and which are reflected again from the reflecting surface 17 on the clip 1 is greater than in the embodiments shown in FIGS. 1 and 2. Accordingly the action of the embodiment of a warning device as claimed in the invention which is shown in FIG. 3 is further intensified compared to the embodiments show in FIGS. 1 and 2.

In should also be pointed out that in the embodiment which is shown in FIG. 3 the reflector 8 can also be attached to the clip 1 as is shown in FIG. 1, the cord-like element being chosen to be correspondingly shorter.

In summary one embodiment of the invention can be described as follows.

An animal warning device consisting of a holding clip 1 and a reflector 8 with two crossing arms which is attached by way of a cable or a chain 14 to the holding clip 1. On the arms of the reflector 8 there are reflecting surfaces 9. Because the reflector 8 is mounted to hang freely and movably on the holding clip 1, the light of approaching vehicles is arrhythmically relayed into the vicinity of the edge of the road so that a habituation effect does not occur in wild animals. In addition, on the clip 1 there is a reflecting surface 17 which faces the reflector 8.

1. Warning device with at least one reflector (8) which has two crossing arms, which on their ends are provided with reflecting foil (9), the reflector (8) being mounted to move freely on the horizontal leg (2) of a clip (1) which is mounted on a stationary component, characterized in that there is a reflecting surface (17) on the clip (1).

2. Device as claimed in claim 1, wherein there is a reflecting surface on the vertically aligned leg (3) of the clip (1).

3. Device as claimed in claim 1 or, wherein the reflecting surface (17) on the clip (1) is a reflecting foil.

4. Device as claimed in claim 1, wherein the reflecting surface (17) is provided on the side of the vertical leg (3) of the clip (1) facing the reflector (8).

5. Device as claimed in claim 1, wherein the reflecting surface (17) is located on the clip (1) at the same height as the reflector (8).

6. Device as claimed in claim 1, wherein the reflecting surface (17) is provided on the clip (1) next to the reflector (8).

7. Device as claimed in claim 6, wherein the clip (1) is bent and is attached via its vertical leg (3) to the stationary component.

8. Device as claimed in claim 6, wherein the reflector (8) is connected to the horizontal leg (2) of the clip (1) via an elongated flexible element (4, 14′).

9. Device as claimed in claim 8, wherein the element (4) is a cord-like element such as a cord, a chain (14) or a cable.

10. Device as claimed in claim 8, wherein the elongated element (4, 14′) is guided through a hole (7) in the horizontal leg (3) of the clip (1).

11. Device as claimed in claim 10, wherein the cable (4) is pivotally held in the hole (7).

12. Device as claimed in claim 8, wherein the elongated element (4) is inserted through a channel (12) which is located in the crossing area of the arms of the reflector (8).

13. Device as claimed in claim 12, wherein the elongated element (4) is pivotally held in the channel (12).

14. Device as claimed in claim 9, wherein the upper end link of the chain (14) is attached via a cotter pin (15) in the hole (7) of the horizontal leg (2) of the clip (1).

15. Device as claimed in claim 14, wherein a sleeve (16) with a flange which lies on the leg (2) is inserted via the end of the cotter pin (15) which is located above the leg (2).

16. Device as claimed in claim 14, wherein the lower end link of the chain (14) is attached to a pin (10′) which was pivotally inserted through one channel (12) of the reflector (8).

17. Device as claimed in claim 16, wherein a sleeve (11′) with a flange which adjoins the reflector (8) is inserted via the end of the pin (10′) which projects underneath the reflector (8).

18. Device as claimed in claim 2, wherein the reflecting surface (17) on the clip (1) is a reflecting foil.

19. Device as claimed in claim 7, wherein the reflector (8) is connected to the horizontal leg (2) of the clip (1) via an elongated flexible element (4, 14′).

20. Device as claimed in claim 9, wherein the elongated element (4, 14′) is guided through a hole (7) in the horizontal leg (3) of the clip (1).
